(19) United States
(12) Patent Application Publication
(10) Pub. No.: US 2026/0333141 A1
(43) Pub. Date: Oct. 22, 2026

(54) REDUCING NETWORK CONNECTION LATENCY IN A MOBILE BASE STATION RELAY (MBSR) HANOVER BETWEEN TERRESTRIAL AND NON-TERRESTRIAL NETWORKS

(71) Applicant: SHARP KABUSHIKI KAISHA, Sakai City (JP)

(72) Inventors: Kenneth Park, Cathlamet, WA (US); Atsushi Ishii, Vancouver, WA (US); Majid Ghanbarinejad, Lake Forest, CA (US); Tomoki Yoshimura, Camas, WA (US); Sangkyu Baek, Vancouver, WA (US); Rudraksh Shrivastava, Erligheim (DE)

(21) Appl. No.: 19/181,232

(22) Filed: Apr. 16, 2025

(51) Int. Cl. H04W 36/00; H04W 36/38; H04W 84/06

(52) U.S. Cl. CPC H04W 36/0055; H04W 36/0044; H04W 36/38; H04W 84/06

(57) ABSTRACT

A mobile base station relay (MBSR) receives, from an MBSR operator, through a serving network, a first message enabling the MBSR to determine whether the MBSR has an imminent need to transition to a target network. The first message includes one or more conditions for the transition, and a first set of parameters essential to maintain service connectivity for several UEs connected to the serving network through the MBSR. The MBSR determines the conditions are satisfied and sends, to the serving network, a second message, including the first set of parameters, to select the target network and indicate to the target network to prepare a connection to the MBSR before a determination is made transitioning the MBSR to handover from the serving network to the target network. The serving network is either a TN or an NTN and the target network is another one of the TN and the NTN.

### TECHNICAL FIELD

The technology generally relates to wireless communications, and more particularly to reducing network connection latency in a mobile base station relay (MBSR) handover between terrestrial and non-terrestrial networks.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5th generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to grow, however, there is a need for further improvements in wireless communications in the next-generation radio communication systems, such as improvements in providing connectivity for user equipment (UEs) through MBSRs.

### SUMMARY

In a first aspect of the present application, an MBSR is provided. The MBSR includes one or more non-transitory computer-readable media storing one or more computer-executable instructions. The MBSR includes at least one processor that is coupled to the one or more non-transitory computer-readable media, and configured to execute the one or more computer-executable instructions to cause the MBSR to receive, from an MBSR operator, through the serving network to which the MBSR is connected, a first message enabling the MBSR to determine whether the MBSR has an imminent need to transition to a target network, the first message includes a set of one or more conditions for the transition, and a first set of parameters essential to maintain service connectivity for several UEs that are connected to the serving network through the MBSR; determine that the set of conditions is satisfied; send, to the serving network, a second message to select the target network and indicate to the target network to prepare a connection between the MBSR and the target network before a determination is made transitioning the MBSR to handover from the serving network to the target network, the second message includes the first set of parameters. The serving network is one of a terrestrial network (TN) and a non-terrestrial network (NTN) and the target network is another one of the TN and the NTN.

In an implementation of the first aspect, selecting the target network and indicating to the target network to prepare the connection between the MBSR and the target network before the determination is made for the MBSR to handover prevents an interruption to the service connectivity of the several UEs while the connection of the MBSR is transitioning from the serving network to the target network.

In another implementation of the first aspect, the first set of parameters includes one or more of a quality of service (QoS) level requirement for the target network, an expected resource usage by the MBSR over the target network connection, and a maximum latency.

In another implementation of the first aspect, the first message further includes an identification of a second set of parameters, and determining that the set of conditions is satisfied includes monitoring values of the second set of parameters, and determining that the second set of parameters satisfy one or more criteria.

In another implementation of the first aspect, the MBSR is affixed to a vehicle, and the second set of one or more parameters includes at least one of a location of the vehicle, a speed of the vehicle, or an altitude of the vehicle.

In another implementation of the first aspect, the at least one processor is further configured to execute the one or more computer-executable instructions to cause the MBSR to receive, from the MBSR operator, a configuration enabling the MBSR to receive, from a source external to the MBSR, an input into the MBSR indicating the imminent need to transition. Determining that the at the set of the conditions is satisfied includes receiving, from the source external to the MBSR, the input indicating the imminent need to transition.

In another implementation of the first aspect, the at least one processor is further configured to execute the one or more computer-executable instructions to cause the MBSR to receive, from the serving network, a command to prepare to handover to the target network, the command includes a time critical networking-scheduling request (TCN-SR) received from an operator of the target network, the TCN-SR includes a new connection configuration (NCC); and execute the handover using NCC.

In another implementation of the first aspect, the TCN-SR further includes configuration information regarding a use of the target network radio frequency (RF) resources by the MBSR when the MBSR attempts to connect to and maintain a connection to a base station (BS) of the target network.

In another implementation of the first aspect, the at least one processor is further configured to execute the one or more computer-executable instructions to cause the MBSR to activate a dual active protocol stack (DAPS) to maintain a connection with the serving network while simultaneously establishing a connection with the target network.

In another implementation of the first aspect, transmitting the second message to the serving network includes transmitting the second message, to the serving network, via a non-access stratum (NAS) layer.

In another implementation of the first aspect, transmitting the second message to the serving network includes transmitting the second message, to the serving network, through a BS of the serving network via a control channel of a Uu air interface, and from the BS to the serving network via a next generation (NG) interface.

In another implementation of the first aspect, the at least one processor is further configured to execute the one or more computer-executable instructions to cause the MBSR to receive a second set of parameters includes a prioritized list of several target networks from which the serving network to select the target network. The second message further includes the second set of parameters.

In another implementation of the first aspect, the MBSR is affixed to a vehicle. The at least one processor is further configured to execute the one or more computer-executable instructions to cause the MBSR to receive, from the MBSR operator, a second set of parameters that includes one or more of a current location of the vehicle, a window of time when the MBSR is expected to make the transition, an expected travel path of the vehicle, a unique identification (ID) of the MBSR, an expected above the ground level (AGL) of the vehicle when a hand-over is expected. The second message further includes the second set of parameters to be forwarded, by the serving network, to the target network.

In another implementation of the first aspect, the MBSR is affixed to a vehicle, the MBSR is connected to a serving cell of the serving network, the target network includes a target cell to which the MBSR is about to handover, the MBSR operator includes a service operator that operates services to the vehicle, the vehicle includes one of an airplane, a car, a bus, a train, a ship, or a boat, and the several UEs are associated with several passengers of the vehicle.

In a second aspect of the present application, a method is provided. The method includes receiving, at an MBSR, from an MBSR operator, through the serving network to which the MBSR is connected, a first message enabling the MBSR to determine whether the MBSR has an imminent need to transition to a target network, the first message includes a set of one or more conditions for the transition, and a first set of parameters essential to maintain service connectivity for several UEs that are connected to the serving network through the MBSR; determining that the set of conditions is satisfied; transmitting, to the serving network, a second message to select the target network and indicate to the target network to prepare a connection to between the MBSR and the target network before a determination is made transitioning the MBSR to handover from the serving network to the target network, the second message includes the first set of parameters. The serving network is one of a TN and an NTN and the target network is another one of the TN and the NTN.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system that provides service to MBSRs, according to an example implementation of the present disclosure.

FIG. 2 is a sequence diagram illustrating an example message flow of a signaling framework where an MBSR operator indicates an imminent need of the MBSR to transition to an NTN, according to an example implementation of the present disclosure.

FIG. 3 is a sequence diagram illustrating an example message flow of a signaling framework where an MBSR operator indicates an imminent need of the MBSR to transition to a TN, according to an example implementation of the present disclosure.

FIG. 4 is a sequence diagram illustrating an example message flow of a signaling framework to find the first target network with sufficient resources to support the requirements of an MBSR which is in an imminent need to transition to a target network, according to an example implementation of the present disclosure.

FIG. 5 is a sequence diagram illustrating an example message flow of a signaling framework to find a target network with the best available resources to support requirements of an MBSR which is in an imminent need to transition to a target network, according to an example implementation of the present disclosure.

FIG. 6 is a flowchart illustrating an example method/process performed by an MBSR operator for indicating an imminent need of the MBSR to transition to a target network connectivity, according to an example implementation of the present disclosure.

FIG. 7 is a sequence diagram illustrating an example message flow of a signaling framework where an MBSR indicates an imminent need of the MBSR to transition to a target network, according to an example implementation of the present disclosure.

FIG. 8 is a flowchart illustrating an example method/process performed by an MBSR for indicating an imminent need of the MBSR to transition to a target network connectivity, according to an example implementation of the present disclosure.

FIG. 9 is a flowchart illustrating an example method/process performed by a serving network to select a target network and request the target network to prepare a connection between an MBSR and the target network, according to an example implementation of the present disclosure.

FIG. 10 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), LTE-A Pro, and/or a new radio system referred to as 6G. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), a 6G Node B (6 gNB), and any other apparatus capable of controlling radio communication and managing radio resources within a cell. The BS may connect to serve the one or more UEs through a radio interface to the network.

The BS may be operable to provide radio coverage to a specific geographical area using one or more cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR or 6G is to support flexible configurations for accommodating various next generation communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR or 6G waveform. The scalable OFDM numerology, such as the adaptive sub-carrier spacing, the channel bandwidth, and the Cyclic Prefix (CP) may also be used. Additionally, two coding schemes are considered for NR or 6G: (1) Low-Density Parity-Check (LDPC) code and (2) Polar Code. The coding scheme adaption may be configured based on the channel conditions and/or the service applications.

Moreover, it should also be noted that in a transmission time interval of a single NR or 6G frame, a DL transmission period, a guard period, and UL transmission data may at least be included, where the respective portions of the DL transmission data, the guard period, and the UL transmission data should also be configurable, for example, based on the network dynamics of NR or 6G. In addition, sidelink resources may also be provided in an NR or 6G frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Reducing Network Connection Latency in an MBSR Hanover Between Terrestrial and Non-Terrestrial Networks

The 3GPP Specification 22.839 v 18.1 provides the following description for an MBSR. A “mobile base station relay” (or mobile BS relay or MBSR) is a mobile base station acting as a relay between a UE and the 5G network, i.e., providing an NR access link to UEs and connected wirelessly (using NR) through a donor NG-RAN to the 5G Core. Such a mobile BS relay is assumed to be mounted on a moving vehicle and services UEs that can be located inside or outside the vehicle (or entering/leaving the vehicle).

The radio link used between an MBSR and the UEs served by the MBSR, as well as between the MBSR and the donor RAN, is assumed to be NR-Uu. Therefore, it should be understood that an MBSR is different than a UE relay (which instead uses a Proximity-based Communication interface (PC5 interface) link to provide indirect connection to remote UEs). In different realizations, an MBSR may be a BS (e.g., ng-eNB, gNB, 6G BS), a part of a BS (e.g., a Distributed Unit (DU), an Integrated Access and Backhaul Distributed Unit (IAB-DU), an Open RAN DU (O-DU), a Radio Unit (RU), an Open RAN RU (O-RU)), an IAB node, a Wireless Access Backhaul (WAB) node, a femto-cell BS, a Vehicle Mounted Relay (VMR), a Transmission and Reception Point (TRP), a network-controlled repeater, or a combination thereof.

Although the use cases and requirements cover single-hop relay scenarios as baseline, a multi-hop is not precluded and legacy UEs are also supported. The current stage-1 requirements (e.g., on wireless self-backhaul, in Technical Specification TS 22.261), as well as the existing stage-2/3 functionalities and architecture options (e.g., IAB) do not assume or address full relay mobility (e.g., BS relays on board of moving vehicles), thus may not cover the identified new potential requirements, which are intended to be specific to MBSRs.

An MBSR mounted on a vehicle, such as an aircraft, may provide a single connection (of aggregated users connections of several users on board the aircraft and wirelessly connected to the MBSR) between the aircraft and a Terrestrial Network (TN) BS or between the aircraft and a Non-Terrestrial Network (NTN) BS. The single connection may be, for example, the aggregated connections of the UEs on board the aircraft and attached to the MBSR.

However, the transition from the TN BS service to the NTN BS service may cause the MBSR to encounter some latency as the non-terrestrial core network may need time to determine the availability of resources (e.g., satellites, network routing, ground stations, etc.). The non-terrestrial core network may need additional time, after the determination of the available resources, to activate these resources prior to a new connection established between the MBSR and the NTN BS (e.g., prior to the handover from the TN BS to the NTN BS), and by extension in the activation of the non-terrestrial core resources. Similar issues may exist for the transition from the NTN BS service to the TN BS service. This additional latency, if not handled with some pre-planning and coordination by the operator of the MBSR and the terrestrial and non-terrestrial core networks, may be sufficient to interrupt the passengers'connections, causing interruption to their services.

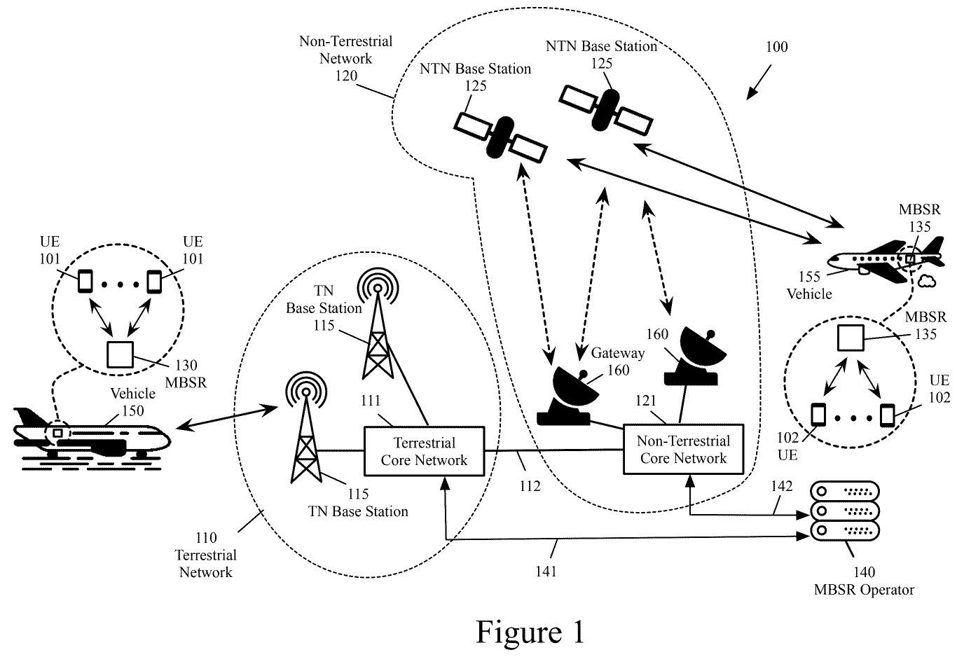

The present disclosure provides several methods to reduce network connection latency in an MBSR handover between TN and NTN. FIG. 1 is a schematic diagram illustrating a radio communication system 100 that provides service to several MBSRs, according to an example implementation of the present disclosure. The radio communication system 100 may include several TNs 110, several NTNs 120, several MBSRs 130-135, one or more MBSR operators 140, several vehicles 150-155, and several UEs 101-102. For clarity, only one TN and one NTN are shown in FIG. 1. Different TNs and NTNs may belong to, and/or operated by, different operators. Each TN 110 may include several TN BSs 115 and a core network 111. Each NTN 120 may include several NTN BSs 125, and a core network 116, several gateways 160 (or ground stations), and a core network 121. The core network 111 or the core network 121 may act as the central hubs for routing and managing traffic between different parts of the corresponding network as well as functions like authentication, authorization, and billing. The core networks 111 or 121 may include various hardware and software components like routers, switches, and network management systems. The core networks 111 and 121 may be connected to each other, for example, and without limitations, through an Internet protocol (IP) connection 112.

The MBSRs 130-135 may be mobile base stations that act as relays between the UEs 101-102 and a communication network, such as the TN 110 or the NTN 120. The TN 110 may be, for example, the 5G network. An MBSR 130-135 may provide an access link (e.g., an NR access link) to one or more UEs 101-102 and may be wirelessly connected to the TN 110 through a TN BS 115 or to the NTN 120 through an NTN BS 125. The MBSRs 130-135 may be affixed to vehicles 150-155, respectively. The MBSRs 130-135 may service the UEs 101-102, that may be located inside or outside of the vehicles 150-155 (e.g., entering or leaving the vehicles).

The vehicles may be flying vehicles (e.g., aircrafts), waterborne vehicles (e.g., ships, boats, or gondolas), or a land vehicles (e.g., trains, buses, or cars), or any other means of conveyance that provides for the mobility of passengers, and by extension, the 3GPP enabled devices associated with the passengers. The passengers may have one or more 3GPP enabled devices that are capable of establishing connections to a 3GPP BS.

It should be noted that some of the examples provided in the present disclosure focus on an MBSR mounted on an aircraft and serving the users inside, or close to, the aircraft, and some of the issues that may be particular to an aircraft deployment (e.g., significate changes in altitude and speed). However, the invention is applicable to an MBSR in other deployments.

Examples of MBSR uses cases include an MBSR on an aircraft to service the passengers on the aircraft. The passengers may have one or more UEs that may use the MBSR for connectivity to a TN BS while on the ground and subsequently, or previously, to an NTN BS while airborne. Another use-case may be an MBSR on a container ship such that each container on the ship has a Narrowband Internet of Things (NB-IoT) device attached to it (e.g., to report the container's status). In the container ship use case, most of the devices connected to the MBSR are not associated with a human passenger as the MBSR on the container ship may be used to provide connectivity between the NB-IoT devices associated with a container and a TN BS when the ship is in port, or between the NB-IoT devices associated with a container and an NTN BS when the ship is at sea.

Therefore, the most general form of the use-cases is that of a conveyance that transports 3GPP enabled devices (e.g., UE, NB-IoT, etc.) from a location where there is TN coverage to a location that has limited or no TN coverage and to a location where NTN coverage is available. The MBSR may be used to aggregate the connections of the 3GPP enabled devices that are expected to move with the conveyance, and the MBSR may establish a connection to either a TN BS or an NTN BS to facilitate service to the aggregated devices.

The network that provides the connection to the MBSR prior to the handover is referred to as the serving network (and in some embodiments, the servicing network), and the network to which the MBSR's connection is transitioned is referred to as the target network. In this disclosure, the terms serving network and servicing network may be used interchangeably.

An MBSR 130-135 may be used in scenarios where there are areas of degraded RF coverage of a mobile network's serving BS, or areas where a mobile network's serving BS is not desirable for reasons other than degraded RF coverage by providing an alternate connection to the mobile serving BS that is not impacted by degraded RF coverage, or areas where the mobile serving BS is desirable for reasons other than RF coverage.

For example, the passengers inside a commercial aircraft may experience poor RF connectivity between their 3GPP enabled devices and a TN BS or an NTN BS due to the physical characteristics of the aircraft. To address these issues, commercial (and private) aircrafts may be configured with an MBSR. The MBSR may be able to provide a high-quality RF connection to the UEs inside the aircraft by acting as a BS. The MBSR may use an antenna external to the aircraft to establish backhaul and fronthaul connections (separate from the RF connection inside the aircraft) to a TN BS or an NTN BS.

An additional benefit of implementing an MBSR on an aircraft is that the high density of connections from inside an aircraft to a TN BS may place temporal RF resource dimensioning demands on a TN BS, as compared to a normal (e.g., wider and more random) distribution of connections outside of the aircraft.

In addition, the MBSR on an aircraft may provide a single connection (of the aggregated users) between the aircraft and a TN BS or an NTN BS (the single connection carrying an aggregation of users'connections). The criteria for a selection between a TN BS and an NTN BS for connectivity is normally aligned with the operating state of the aircraft. For example, while on the ground, the MBSR may normally be connected to the TN BS for reasons of cost (e.g., an NTN connection is more expensive than a TN connection). On the other hand, while airborne, the MBSR may normally be connected to an NTN BS for the reasons of (1) poor RF connectivity to the TN and (2) to avoid the potential for a wide system impact due to high altitude transmissions of the MBSR on the TN.

The TN 110 and/or the NTN 120 may, for example, be 3GPP networks that may include core networks, BSs, and other infrastructure. The MBSR connections to the TN and the NTN may occur individually or simultaneously. The TN 110 may be a land-based network that rely on ground-based infrastructure, such as the cell towers and small cells (e.g., femtocells, picocells, and microcells) which are the BSs 115 that transmit signals over land, and fiber-optic backhaul (e.g., the high-speed fiber networks connecting BSs). The TN 110 may, for example, use Millimeter Wave (mmWave) and Sub-6 GHz. The TNs provide high-speed, low-latency connectivity but are limited in coverage, especially in remote areas and high altitudes.

The NTN 120 may extend the coverage beyond the terrestrial infrastructure using space-based and aerial platforms. The NTN 120 may use satellites or high-altitude platform stations (HAPS) as the NTN BSs 125. The satellite-based NTNs may use satellites as the NTN BSs 125. The satellites may be geostationary Earth orbit (GEO) satellites (e.g., ViaSat, HughesNet) that are stationary above Earth, covering large areas. The satellites may be medium Earth orbit (MEO) satellites (e.g., O3b by SES), providing lower latency than GEOs. The satellites may be low Earth orbit (LEO) satellites (e.g., Starlink, OneWeb), offering faster speeds and lower latency due to closer orbits. The NTNs 120 may use HAPS, such as stratospheric balloons, drones, or aircraft that act as airborne base stations. The NTNs 120 may extend the TN's coverage to rural, remote, oceanic, and high-altitude areas. The NTNs 120 may enable global Internet of Things (IoT) and maritime/aviation communication. The NTN 120 shown in FIG. 1 is a satellite based NTN. In other embodiments, the NTN may use HAPS as BSs. The terms base station device, base station, and BS may be used interchangeably herein. The terms user equipment, UE, and terminal device may be used interchangeably herein.

The operator 140 of an MBSR 130-135 may, for example, be an electronic device (e.g., a server) that is operated by a company that is associated with the vehicle 150-155 on which the MBSR is mounted. For example, if the vehicle is an airplane, the MBSR operator 140 may be a server associated with an airline that owns and/or operates the airplane.

The MBSR operator 140 may monitor the operational status of the MBSR via an Application Programing Interface (API) connection 141 to the terrestrial core network 111, and/or through an API connection 142 to the non-terrestrial core network 121. The API connection 141 between the MBSR operator 140 and the terrestrial core network 111, and the API connection 142 between the MBSR operator 140 and the non-terrestrial core network 121 may be via a non-3GPP network (e.g., an IP connection through the Internet). The MBSR operator 140 may also obtain other MBSR operational status via other non-3GPP network connections. The APIs may also allow the terrestrial core network to inform the MBSR operator of the status of the MBSR, such as the MBSR's altitude, speed, direction, current resource usage, etc.

By monitoring the operational status of an MBSR via a terrestrial or non-terrestrial core network's API, the MBSR operator may gather information to determine that, in the near future, the MBSR may need to transition from a TN BS 115 to an NTN BS 125 (or vice versa). The determined need may be based on the inability to maintain the current service level requirements for the user connections aggregated by the MBSR, or that the current operational level requirements of the MBSR's installation cannot be maintained.

The determination by the operator 140 of the MBSR that in the near future the MBSR may need to transition from a TN BS to an NTN BS (or vice versa) to maintain the service level or operational level requirements of the MBSR installation is referred to as “imminent need” in this disclosure. It should be noted that in this disclosure the terms “transition” or “handover” or “connecting” may be used interchangeably, one may be a subset of the other, or they may overlap in terms of processes, such as, handover, link switch, transition, connection switch, etc.

To address and minimize the potential latency of a handover from a serving network BS to a target network BS, where the latency is a function of at least the time required by the target network to determine the availability of resources (e.g., satellites, network routings, ground stations, etc.) to support the new MBSR connection and the activation of these resources prior to the new connection established between the MBSR and the target network BS, the indication of imminent need for the target network connectivity is provided by a serving core network to a target network core network in advance of an expected handover of the MBSR from the serving network BS to the target network BS.

The indication of imminent need provides the technical advantage of providing the target network time in advance of an expected handover to determine the availability of an optimal resource set (e.g., by considering quality of service (QoS), availability, cost, etc.) for servicing the MBSR. The allocation of such resources to service the MBSR (e.g., beam set of Non-Geosynchronous Orbit (NGSO), Geosynchronous Orbit (GSO), or both when the target network is an NTN) and the enabling of such resources at the appropriate time, may reduce (or eliminate) the latency for the transition of the MBSR from a serving network BS connection to a target network BS connection.

To maintain clarity, the following discussions provides an example of an MBSR transitioning from a TN to an NTN. It should be understood that the discussions is equally applicable to the transition of the MBSR from an NTN to a TN.

The transition from a TN BS to an NTN BS services may cause the MBSR to encounter some latency as the NTN system may need time to determine the availability of resources (e.g., satellites, network routings, ground stations, etc.) and then some more time after the determination of available resources to activate the resources prior to the new connection established between the MBSR and the NTN system (e.g., handover from the TN BS to the NTN BS and the activation of the non-terrestrial core network resources).

When the MBSR operator 140 determines an imminent need for the MBSR to transition its connection from the TN BS to a NTN BS, the operator of the MBSR may make a request to the terrestrial core network (via the APIs at the terrestrial core network) to request that a connection to an NTN BS be prepared (e.g., the radio frequency (RF) and network resources be allocated) in advance of the handover from the TN BS to an NTN BS. The MBSR operator 140 may also include, with the imminent need request sent to the terrestrial core network, additional information regarding the MBSR's expected service level requirements and operational requirements (e.g., the RF and network resources required), and a prioritized list of non-terrestrial core networks from which the terrestrial core network may select a non-terrestrial core network for the MBSR to transition to.

Alternately, the MBSR operator 140 may configure the MBSR such that the MBSR may monitor its own status and gather such information as necessary to make its own determination of an imminent need for the MBSR to transition its connection from the TN BS to an NTN BS. In such a case, the MBSR operator may send a request to the terrestrial core network to enable the MBSR to make a request of imminent need to the terrestrial core network. The enable request from the operator of the MBSR to the terrestrial core network may also include one or more parameters that enable the MBSR to send the indication of immanent need when the conditions at the MBSR satisfy the condition of a parameter or a combination of parameters. If the condition(s) of the parameter(s) is/are satisfied at the MBSR, the MBSR may make a request to the terrestrial core network, via the 3GPP connection, to select a target network and request the target network to prepare a connection to an NTN BS before a determination is made to handover the MBSR from the TN BS to the NTN BS. The MBSR may also include, with the imminent need request sent to the terrestrial core network, additional information regarding the MBSR expected service level requirements and operational requirements.

After the TN operator receives an imminent need request (and other information) from the operator of the MBSR (or alternately from the MBSR), the TN operator may send a request to an NTN operator requesting that it reserve and prepare the necessary resources to support a new MBSR connection. The necessary resources may be described by the other information included with the imminent need request.

The NTN operator may, or may not, allocate sufficient resources as requested by the TN operator to support a new MBSR connection. The NTN operator may report back to the TN operator with a status report (e.g., a time critical networking-scheduling request (TCN-SR)) indicating the level of resources that has been (or has not been) allocated. The NTN operator may also report back to the TN operator, as part of the TCN-SR, a new connection configuration (NCC) to be used by the MBSR when connecting to the NTN BS.

The NCC may include a set of parameters for configuring the MBSR's use of the NTN resources (e.g., the resources that have been allocated by the non-terrestrial core network for use by the MBSR as a result of the imminent need request, the service level requirements, and operation aspects of the MBSR) at the time of the expected no latency (or low latency) transition of the MBSR from a TN connection to an NTN connection.

If the TN operator receives a TCN-SR, it may then forward the NCC in the TCN-SR to the MBSR along with a command to prepare to handover to the NTN BS when the TN link fails (or alternately, to immediately handover to the NTN BS, or to handover to the NTN BS when some local conditions are met, or when an external signal is received) using the NCC.

After the TN operator receives the TCN-SR, the TN operator may determine that the level of resources indicated in the TCN-SR for a new MBSR connection is not sufficient, and the TN operator may make a different imminent need request to a different NTN operator in an attempt to obtain the desired level of resources for the MBSR. The terrestrial core network may select the next non-terrestrial core network from a prioritized list of non-terrestrial core networks. The terrestrial core network may select the first non-terrestrial core network from the prioritized list of non-terrestrial core networks that provides sufficient resources to meet the MBSR's requested service level requirements and operational aspects as the target network for the MBSR to handover to. In a case that the terrestrial core network exhausts all possible non-terrestrial core networks in the prioritized list, the terrestrial core network may select the non-terrestrial core network that is able to provide the most resources in support of MBSR's requested service level requirements and operational aspects as the target for the MBSR to handover to.

The terrestrial core network upon determination of a non-terrestrial core network that best meets or exceeds the MBSR's requested service level requirements and operational aspects, may command the MBSR to either prepare, and wait, for a failing TN BS link to begin handover to that NTN BS, or the terrestrial core network may command the MBSR to immediately handover to the NTN BS, or to prepare for an external signal to begin the handover to the NTN BS.

The determination by the terrestrial core network to command the MBSR to wait for failing of the TN link to handover to the NTN BS or immediately handover to the NTN BS may be based on the content of the TCN-SR or may be determined by the TN operations and policy, or may be a combination of both.

The terrestrial core network, upon the receipt of the TCN-SR from the non-terrestrial core network, may forward to the MBSR the NCC in the TCN-SR if it the TCN-SR meets or exceeds the service level requirements of the MBSR. Alternately, the terrestrial core network may forward to the MBSR the NCC of a TCN-SR that provides the best level of service from a set of TCN-SRs acquired from the list of non-terrestrial core networks.

If an MBSR receives a command from the TN BS to prepare to handover to the NTN BS, the MBSR may execute the handover using the NCC supplied by the NTN operator's TCN-SR and forwarded to the MBSR via the TN BS. The use of the NCC may expedite the MBSR's access to the resources of the NTN BS. When the MBSR receives a command from the TN BS to prepare to handover to the NTN BS, the MBSR may activate a Dual Active Protocol Stack (DAPS) feature to maintain a connection with the terrestrial core network while simultaneously establishing a connection with the non-terrestrial core network. The DAPS may provide the technical advantage of allowing the MBSR to simultaneously use a first protocol stack to maintain the connection of the TN BS and a second protocol stack to establish the new connection to the NTN.

The MBSR operator 140 may be triggered to inform the terrestrial core network of the imminent need. The trigger, in some embodiments, may be from an external input to the operator of the MBSR. For example, the external input may be a signal received from a central controller, which may be connected to a controller of the airport/terminal. The central controller may, for example, be a central controller that tracks the Air Traffic Controller (ATC) clearance of the aircraft.

The trigger, in some embodiments, may be from a terrestrial core network interface API to the operator of the MBSR. For example, the trigger may be a signal from the terrestrial core network that forwards parameters from the MBSR 130-135 such as the sensors that detect the speed, the altitude and/or the location associated with the aircraft to the operator of the MBSR 140.

Alternately, the terrestrial core network may provide functionality that allows the MBSR to inform the terrestrial core network of the imminent need for the MBSR to transition between the TN service and the NTN service. Such functionality provided by the terrestrial core network to the MBSR may be facilitated by an NSA layer communication channel between the MBSR and the terrestrial core network, or it may be facilitated by in-band control signaling between the MBSR and the TN BS via the Uu interface, and between the TN BS to the terrestrial core network via the NG interface. Via the information provided by the functionality, the terrestrial core network may then inform the non-terrestrial core network of the imminent need for the use of NTN resources by an MBSR.

The indication of immanent need, in some embodiments, may be sent by the MBSR 130-135 to the terrestrial core network. In such a case, the MBSR 130-135 may have been configured with one or more parameters by the MBSR operator 140 that enable the MBSR to send the indication of immanent need when the conditions at the MBSR satisfy the conditions of one or more parameters. For example, if the MBSR is configured with a parameter for speed, such as 60 miles per hour (mph), the MBSR may send an indication of imminent need when the speed of the MBSR transitions from lower than 60 mph to higher than 60 mph, or vice versa.

As another example, if the MBSR is configured with a parameter for altitude Above Ground Level (AGL), such as 100 feet, the MBSR may send an indication of imminent need when the altitude AGL of the MBSR transitions from lower than 100 feet to higher than 100 feet, or vice versa. As another example, if the MBSR is configured with a set of parameters for speed and altitude AGL, such as 60 mph and 100 feet, the MBSR may send an indication of imminent need when the speed and altitude AGL of the MBSR transition from lower than 60 mph and 100 feet, respectively to higher than 60 mph and 100 feet, or vice versa.

The MBSR may be triggered (when configured to do so by the MBSR operator as described above) to inform the terrestrial core network of the imminent need. Such a trigger may be from an external input to the MBSR such as a signal from the aircraft upon the pilots/operators initiating a start or stop of the aircraft or a signal from a sensor that detects a speed and/or location associated with the start or stop of the aircraft.

In addition to the indication of imminent need that is provided by the terrestrial core network to the non-terrestrial core network in advance of the handover of the MBSR from the TN BS to the NTN BS, the non-terrestrial core network may also receive from the terrestrial core network information related to the expected service level required by the MBSR (e.g., QoS level that the NTN service should provide, the expected resource usage by the MBSR over the NTN connection, latency maximus, etc.) and operational aspects of the MBSR (e.g., the current location of the MBSR, an expected window of time when the MBSR may need to make the transition, the expected travel path of the MBSR, the unique identification (ID) of the MBSR, the expected aircraft altitude AGL when the handover is expected, the expected aircraft speed when the handover is expected) and other essential information related to the continuity of services currently provided by the MBSR.

### Imminent Need Sent BT The MBSR Operator

The indication of the immanent need, in some embodiments may be sent by the MBSR operator to the serving core network. The serving network may be the TN, and the target network may be the NTN. Alternatively, the serving network may be the NTN, and the target network may be the TN.

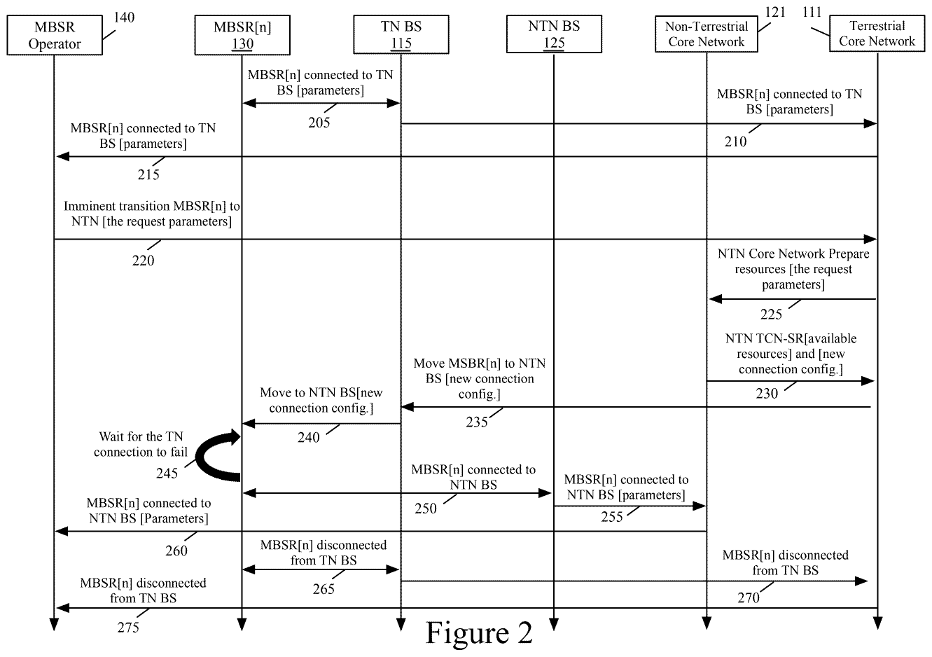

FIG. 2 is a sequence diagram illustrating an example message flow of a signaling framework where an MBSR operator indicates an imminent need of the MBSR to transition to an NTN, according to an example implementation of the present disclosure. With reference to FIG. 2, the TN BS 115, the NTN BS 125, and the MBSR operator 140 may be similar to the corresponding entities shown in FIG. 1. The MBSR[n] 130 (e.g., one of the n MBSRs) may be an MBSR, such as the MBSR 130 shown in FIG. 1. The terrestrial core network 111 may be the core network of a TN, such as the TN 110, shown in FIG. 1. The non-terrestrial core network 121 may be the core network of an NTN, such as the NTN 120, shown in FIG. 1.

As shown in FIG. 2, the MBSR[n] 130 may be connected (at step 205) to the TN BS 115. For example, the MBSR[n] 130 may be on an aircraft 150 located on the ground. The TN BS 115 may receive parameters, such as, speed, altitude, location, current resource usage, etc., from the MBSR[n] 130. The parameters may be forwarded (at step 210) from the TN BS 115 to the terrestrial core network 111. The parameters may be forwarded (at step 215) from the terrestrial core network 111 to the MBSR operator 140.

The MBSR operator 140 may monitor the operational status of MBSR[n] 130 (e.g., parameters such as the MBSR's altitude, speed, direction, current resource usage, etc.) by examining the MBSR parameters via the API connections to the terrestrial core network 111.

By monitoring the operational status of the MBSR[n] 130, the MBSR operator 140 may gather information to determine that, in the near future, the MBSR[n] 130 may need to transition from the TN BS 115 to an NTN BS, such as the NTN BS 125. The determined need may be based on the inability to maintain the current service level requirements for the user connections aggregated by the MBSR[n] 130, or that the current operational level requirements of the MBSR's installation cannot be maintained.

The MBSR operator 140 may indicate (at step 220), to the terrestrial core network 111, the imminent transition of MBSR[n] 130 to an NTN. The indication of immanent need to transition may be sent by the MBSR operator 140 to the terrestrial core network through the APIs provided by the terrestrial core network 111. The MBSR operator 140 may, for example, use an IP connection to access the terrestrial core network's APIs.

The indication of imminent need may include a first set of parameters. The first set of parameters may include information regarding the expected service level required by the MBSR[n] 130 (e.g., the QoS level that a non-terrestrial core network service should provide, the expected resource usage by the MBSR[n] 130 over the non-terrestrial core network connection, latency maximus, etc.).

The indication of imminent need may also include a second set of parameters. The second set of parameters may contain information regarding the operational aspects of the MBSR[n] 130 (e.g., the current location of the MBSR[n] 130, an expected window of time when the MBSR[n] 130 may need to make the transition, the expected travel path of the MBSR[n] 130, the unique ID of the MBSR[n] 130, the expected altitude AGL (if the vehicle to which MBSR[n] 130 is affixed is an aircraft) when the handover is expected, and other essential information related to the continuity of services currently required by the MBSR[n] 130.

The indication of imminent need may also include a third set of parameters. The third set of parameters may include a prioritized list of non-terrestrial core networks from which the terrestrial core network 111 may select from, and make a request to reserve sufficient resources to service the imminent connection of MBSR[n] 130.

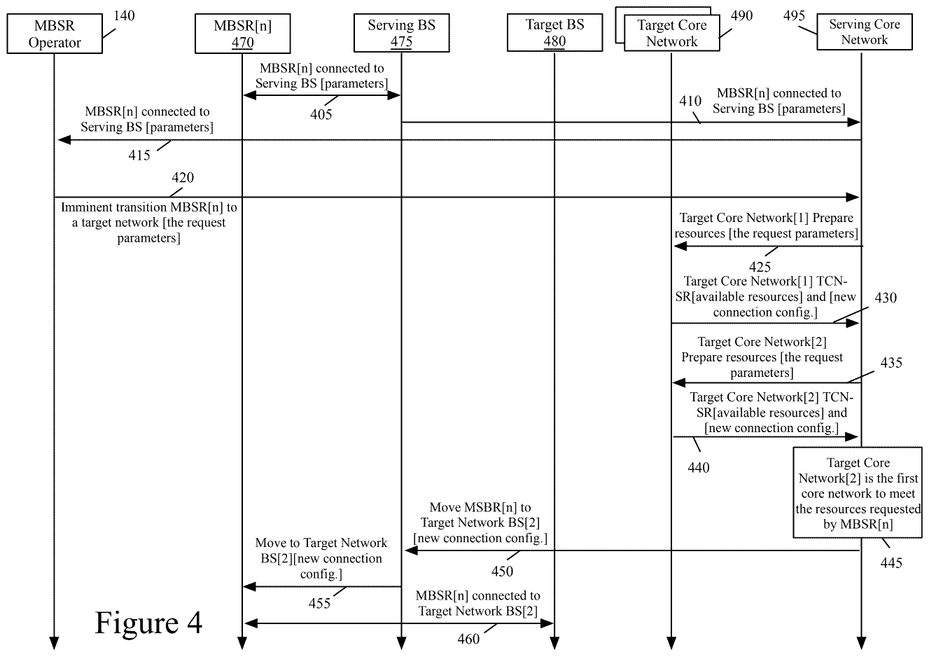

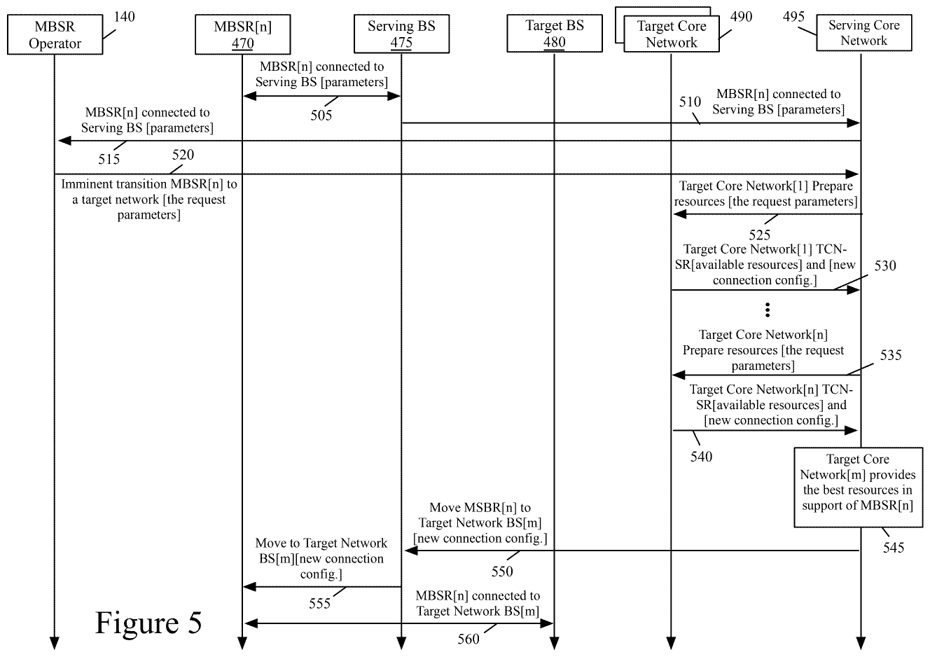

The terrestrial core network 111 may send (or transmit) a request (at step 225) to a non-terrestrial core network 121121 (e.g., an NTN identified by the third set of parameters) to request the non-terrestrial core network 121 to reserve and prepare the necessary resources to support a new MBSR connection. It should be noted that the terms “send” and “transmit” may be used interchangeably herein. The parameters in the request may include the description of the necessary resources. Details of the selection of the NTN to service the new MBSR connection are described below with reference to FIGS. 4 and 5.

Once the terrestrial core network 111 selects the best non-terrestrial core network to provide the new connection to the MBSR[n] 130, the non-terrestrial core network 121 may send (at step 230) a status report (e.g., a TCN-SR) to the terrestrial core network 111 to indicate the resources that has been (or has not been) allocated. The TCN-SR may include an NCC to be used by the MBSR[n] 130 when connecting to the NTN BS 125.

The terrestrial core network 111 may send (at step 235) the NCC to the TN BS 115 to which MBSR[n] 130 is connected to indicate to the MBSR[n] 130 to be prepared to move to the NTN BS 125. The TN BS 115 may send (at step 240) the NCC to MBSR[n] 130 with a command to prepare to handover to the NTN BS 125 when the TN link fails. In some embodiments, the TN BS 115 may instead command MBSR[n] 130 to immediately handover to the NTN BS 125. In other embodiments, the TN BS 115 may command MBSR[n] 130 to wait for some local conditions to be met (e.g., speed, location, altitude AGL, etc.) before the handover to the NTN BS 125. In some embodiments, the TN BS 115 may command MBSR[n] 130 to wait for an external signal to handover to the NTN BS 125.

MBSR[n] 130 may wait (at step 245) for the condition indicated by the TN BS 115 to be satisfied to handover to the NTN BS 125. When the condition for handover is satisfied, the MBSR[n] 130 may activate a DAPS feature to maintain a connection with the TN BS 115 while simultaneously establishing a connection with the NTN BS 125.

MBSR[n] 130 may connect (at step 250) to the NTN BS 125. The NTN BS 125 may send (at step 255) the MBSR[n] 130 status parameters (e.g., location, speed, altitude, current resource usage, etc.) to the non-terrestrial core network 121. The non-terrestrial core network 121 may provide (at step 260) the MBSR[n] 130 status parameters to the MBSR operator 140 to monitor. The non-terrestrial core network 121 may provide the status parameters to the MBSR operator 140, for example, through a set of APIs.

The TN BS 115 and MBSR[n] 130 may complete (at step 265) the disconnection of the MBSR[n] 130 from the TN BS 115. The TN BS 115 may indicate (at step 270) to the terrestrial core network 111 that MBSR[n] 130 is disconnected from the TN BS 115. The terrestrial core network 111 may indicate (at step 275) to the MBSR operator 140 (e.g., through the APIs provided by the terrestrial core network 111 to the MBSR operator 140) that the connection between MBSR[n] 130 and the TN BS 115 is disconnected.

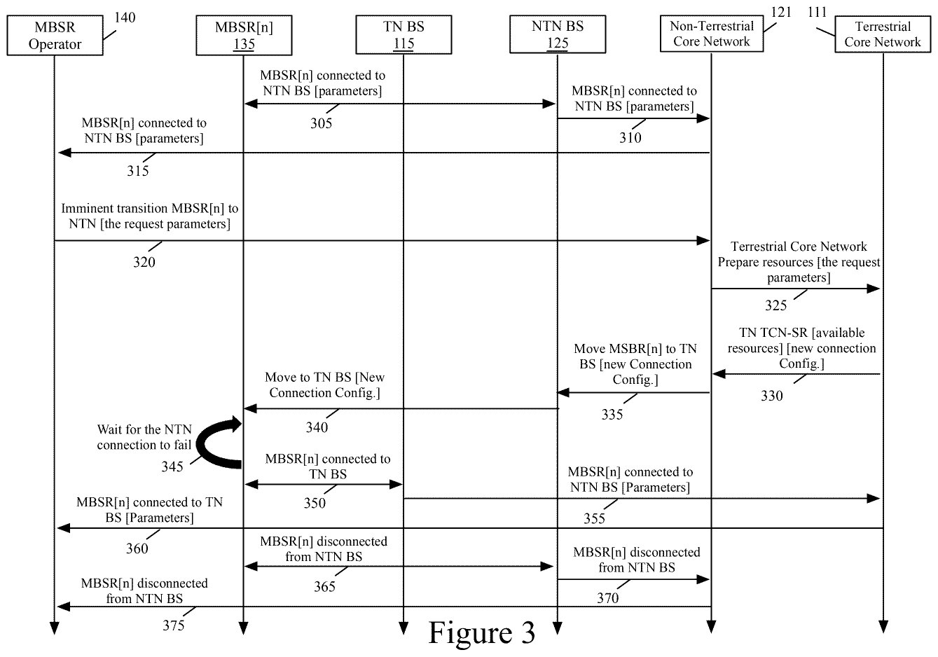

FIG. 3 is a sequence diagram illustrating an example message flow of a signaling framework where an MBSR operator indicates an imminent need of the MBSR to transition to a TN, according to an example implementation of the present disclosure. FIG. 3 provides the message flow when the MBSR is connected to an NTN BS and there is an imminent need to move the connection to a TN BS (e.g., when the airplane 155 is about to land in an airport).

With reference to FIG. 3, the TN BS 115, the NTN BS 125, and the MBSR operator 140 may be similar to the same entities shown in FIG. 1. The MBSR[n] 135 may be an MBSR, such as the MBSR 133 (e.g., an MBSR affixed to a vehicle that is about to gain connectivity with a TN) shown in FIG. 1. The terrestrial core network 111 may be the core network of a TN, such as the TN 110, shown in FIG. 1. The non-terrestrial core network 121 may be the core network of an NTN, such as the NTN 120, shown in FIG. 1.

As shown in FIG. 3, the MBSR[n] 135 may be connected (at step 305) to the NTN BS 125. The NTN BS 125 may receive parameters, such as, speed, altitude, location, current resource usage, etc., from the MBSR[n] 135. The parameters may be forwarded (at step 310) from the NTN BS 115 to the non-terrestrial core network 121. The parameters may be forwarded (at step 315) from the non-terrestrial core network 111 to the MBSR operator 140.

The MBSR operator 140 may monitor the operational status of MBSR[n] 135 (e.g., parameters such as the MBSR's altitude, speed, direction, current resource usage, etc.) by examining the MBSR parameters via the API connections to the non-terrestrial core network 121.

By monitoring the operational status of the MBSR[n] 135, the MBSR operator 140 may gather information to determine that, in the near future, the MBSR[n] 135 may need to transition from the NTN BS 125 to a TN BS, such as the TN BS 115. The determined need may be based on the inability to maintain the current service level requirements for the user connections aggregated by the MBSR[n] 135, or that the current operational level requirements of the MBSR's installation cannot be maintained.

The MBSR operator 140 may indicate (at step 320), to the non-terrestrial core network 121, the imminent transition of MBSR[n] 135 to a TN. The indication of immanent need to transition may be sent by the MBSR operator 140 to the non-terrestrial core network 121 through the of APIs provided by the non-terrestrial core network 121. The MBSR operator 140 may, for example, use an IP connection to access the non-terrestrial core network's APIs.

The indication of imminent need may include a first set of parameters. The first set of parameters may include information regarding the expected service level required by the MBSR[n] 135 (e.g., the QoS level that a terrestrial core network service should provide, the expected resource usage by the MBSR[n] 135 over the terrestrial core network connection, latency maximus, etc.).

The indication of imminent need may also include a second set of parameters. The second set of parameters may contain information regarding the operational aspects of the MBSR[n] 135 (e.g., the current location of the MBSR[n] 135, the expected window of time when the MBSR[n] 135 may need to make the transition, the expected travel path of the MBSR[n] 135, the unique ID of the MBSR[n] 135, the expected altitude AGL (if the vehicle to which MBSR[n] 135 is affixed is an aircraft) when the handover is expected, and other essential information related to the continuity of services currently required by the MBSR[n] 135.

The indication of imminent need may also include a third set of parameters. The third set of parameters may include a prioritized list of terrestrial core networks from which the non-terrestrial core network 121 may select from, and make a request to reserve sufficient resources to service the imminent connection of MBSR[n] 135.

The non-terrestrial core network 121 may send a request (at step 325) to a terrestrial core network 111 (e.g., a terrestrial core network listed in the third set of parameters) to request the terrestrial core network 111 to reserve and prepare the necessary resources to support a new MBSR connection. The parameters in the request may include the description of the necessary resources. Details of the selection of the TN to service the new MBSR connection are described below with reference to FIGS. 4 and 5.

Once the non-terrestrial core network 121 selects the best terrestrial core network to provide the new connection to the MBSR[n] 135, the terrestrial core network 111 may send (at step 330) a status report (e.g., a TCN-SR) to the non-terrestrial core network 121 to indicate the resources that has been (or has not been) allocated. The TCN-SR may include an NCC to be used by the MBSR[n] 135 when connecting to the TN BS 115.

The non-terrestrial core network 121 may send (at step 335) the NCC to the NTN BS 125 to which MBSR[n] 135 is connected to indicate to the MBSR[n] 135 to be prepared to move to the TN BS 115. The NTN BS 125 may send (at step 340) the NCC to MBSR[n] 135 with a command to prepare to handover to the TN BS 115 when the NTN link fails. In some embodiments, the NTN BS 115 may instead command MBSR[n] 135 to immediately handover to the TN BS 115. In other embodiments, the NTN BS 125 may command MBSR[n] 135 to wait for some local conditions to be met (e.g., speed, location, altitude AGL, etc.) before the handover to the TN BS 115. In some embodiments, the NTN BS 125 may command MBSR[n] 135 to wait for an external signal the handover to the TN BS 115.

MBSR[n] 135 may wait (at step 345) for the condition indicated by the NTN BS 125 to be satisfied to handover to the TN BS 115. When the condition for handover is satisfied, the MBSR[n] 135 may activate a DAPS feature to maintain a connection with the NTN BS 125 while simultaneously establishing a connection with the TN BS 115.

MBSR[n] 135 may connect (at step 350) to the TN BS 115. The TN BS 115 may send (at step 355) the MBSR[n] 135 status parameters (e.g., location, speed, altitude AGL, etc.) to the terrestrial core network 111. The terrestrial core network 111 may provide (at step 360) the MBSR[n] status parameters to the MBSR operator 140 to monitor. The terrestrial core network 111 may provide the status parameters to the MBSR operator 140, for example, through a set of APIs.

The NTN BS 125 and MBSR[n] 135 may complete (at step 365) the disconnection of the MBSR[n] 135 from the NTN BS 125. The NTN BS 125 may indicate (at step 370) to the non-terrestrial core network 121 that MBSR[n] 135 is disconnected from the NTN BS 125. The non-terrestrial core network 121 may indicate (at step 375) to the MBSR operator 140 (e.g., through the APIs provided by the non-terrestrial core network 121 to the MBSR operator 140) that the connection between MBSR[n] 135 and the NTN BS 125 is disconnected.

FIG. 4 is a sequence diagram illustrating an example message flow of a signaling framework to find the first target network with sufficient resources to support the requirements of an MBSR which is in an imminent need to transition to a target network, according to an example implementation of the present disclosure. FIG. 4 provides further details for steps 225 and 230 of FIG. 2 and steps 325 and 330 of FIG. 3.

With reference to FIG. 4, the MBSR operator 140 may be similar to the MBSR operator 140 shown in FIGS. 2 and 3. The MBSR[n] 470 may be similar to MBSR[n] 130 or MBSR[n] 135 shown in FIG. 2 or 3, respectively. The serving BS 475 may be similar to the TN BS 115, or the NTN BS 125 shown in FIG. 2 or 3, respectively. The target BS 480 may be similar to the NTN BS 125, or the TN BS 115 shown in FIG. 2 or 3, respectively. The serving core network 495 may be similar to the terrestrial core network 111 or the non-terrestrial core network 121 shown in FIG. 2 or 3, respectively. The target core network 490 may be similar to the non-terrestrial core network 121 or the terrestrial core network 111 shown in FIG. 2 or 3, respectively. As described below with reference to FIGS. 4, 5, and 7, the serving core network 495 may contact several different target core networks, collectively shown in the figures as item 490). Steps 405-420 in FIG. 4 may be similar to steps 205-220 or 305-320 shown in FIG. 2 or 3, respectively.

The serving core network 495 may select (at step 425) from the list of prioritized target core networks, a first target core network of highest priority to check if it is able to reserve sufficient resources to service the imminent connection of MBSR[n] 470. The sufficient resources may be defined by the first and second parameter sets described above, which are received by the serving core network 495 from the MBSR operator 140.

The first target core network 490 may reply (at step 430) to the serving core network 495 with a target core network status report (TCN-SR) in response to the request for immanent connection of the MBSR[n] 470. The TCN-SR may indicate the level of resources that the target core network 490 allocate in support the immanent connection of MBSR[n] 470 per the first and second parameter sets.

The serving core network 495 may determine, from the content of the TCN-SR, that the first target core network is unable to provide sufficient resources to support and maintain the service continuity of MBSR[n] 470. In which case, the serving core network 495 may request (at step 435) the target core network with the next highest priority from the list of prioritized target core networks to reserve sufficient resources to service the imminent connection of an MBSR[n] 470. The sufficient resources may be defined by the first and second parameter sets, described above, which are received by the serving core network 495.

The next target core network 490 may reply (at step 440) to the serving core network 495 with a target core network status report (TCN-SR) in response to the request for immanent connection of the MBSR[n] 470. It should be noted that the next target core network in step 440 (which is identified in FIG. 4 as the target core network[2]) is different than the target core network in step 430 (which is identified in FIG. 4 as the target core network[1]). The TCN-SR may indicate the level of resources that the next target core network 490 is able to allocate in support the immanent connection of MBSR[n] 470 per the first and second parameter sets.

The serving core network 495 may eventually determine, from the content of a TCN-SR, that a target core network from the list of prioritized target core networks is able to provide sufficient resources to support and maintain the service continuity of MBSR[n] 470. In the example of FIG. 4, the serving core network 495 determines (at block 445) that the target core network[2] is able to provide sufficient resources to support and maintain the service continuity of MBSR[n] 470. In which case, the serving core network 490 may request (at step 450) the serving BS 475, of the serving core network, connected to the MBSR[n] 470 to command the MBSR to transition to the target BS 480 of the target core network[2] which is determined to have sufficient resources. Steps 455-460 of FIG. 4 are similar to steps 235-240 or steps 335-340 of FIGS. 2 and 3, respectively. Other steps of FIG. 4 are similar to the corresponding steps of FIGS. 2 and 3 and are not shown in FIG. 4 for clarity.

FIG. 5 is a sequence diagram illustrating an example message flow of a signaling framework to find a target network with the best available resources to support requirements of an MBSR which is in an imminent need to transition to a target network, according to an example implementation of the present disclosure. FIG. 5 provides further details for steps 225 and 230 of FIG. 2 and steps 325-330 of FIG. 3.

With reference to FIG. 5, the MBSR operator 140, the MBSR[n] 470, the serving BS 475, the target BS 480, the serving core network 495, and the target core network 490 may be similar to the corresponding entities shown in FIG. 4. Steps 505-520 in FIG. 4 may be similar to steps 205-220, 305-320, and 405-420 shown in FIGS. 2, 3, and 4, respectively.

The serving core network 495 may select (at step 525) from the list of prioritized target core networks, a first target core network of highest priority to check if it is able to reserve sufficient resources to service the imminent connection of MBSR[n] 470. The sufficient resources may be defined by the first and second parameter sets described above, which are received by the serving core network 495 from the MBSR operator 140.

The first target core network 490 may reply (at step 530) to the serving core network 495 with a target core network status report (TCN-SR) in response to the request for immanent connection of the MBSR[n] 470. The TCN-SR may indicate the level of resources that the target core network 490 allocates in support the immanent connection of MBSR[n] 470 per the first and second parameter sets.

The serving core network 495 may determine, from the content of the TCN-SR, that the first target core network is not able to provide sufficient resources to support and maintain the service continuity of MBSR[n] 470. In which case, the serving core network 495 may request (at step 535) the target core network with the next highest priority from the list of prioritized target core networks to reserve sufficient resources to service the imminent connection of an MBSR[n] 470. The sufficient resources may be defined by the first and second parameter sets, described above, which are received by the serving core network 495. The next target core network 490 may reply (at step 540) to the serving core network 495 with a target core network status report (TCN-SR) in response to the request for immanent connection of the MBSR[n] 470. The TCN-SR may indicate the level of resources that the next target core network 490 is able to allocate in support the immanent connection of MBSR[n] 470 per the first and second parameter sets.

If all target core networks from the prioritized list of target core networks return TCN-SRs that indicate that the target core network is not able to provide sufficient resources to support and maintain the service continuity of MBSR[n] 470, the serving core network 495 may select the target core network with the best level of resources available for allocation to support and maintain the service continuity of the MBSR[n] 470. In the example of FIG. 5, the serving core network 495 may determine (at block 545) that the target core network[m] provides the best resources in support of MBSR[n] 470. In which case the serving core network 495 may request (at step 550) the serving BS 475, of the serving core network, which is connected to MBSR[n] 470 to command MBSR[n] 470 to transition to the target BS 480 of the target core network 490 with the best level of resources available. Steps 555-560 of FIG. 5 are similar to steps 235-240, steps 335-340, or steps 455-460 of FIGS. 2, 3, and 4, respectively. Other steps of FIG. 5 are similar to the corresponding steps of FIGS. 2 and 3 and are not shown in FIG. 5 for clarity.

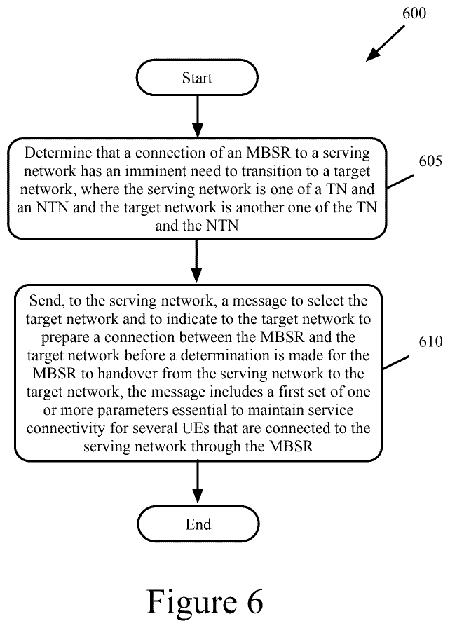

FIG. 6 is a flowchart illustrating an example method/process 600 performed by an MBSR operator for indicating an imminent need of the MBSR to transition to a target network connectivity, according to an example implementation of the present disclosure. With reference to FIG. 6, the process 600 may be performed by at least one processor of an MBSR operator, such as the MBSR operator 140, shown in FIG. 1.

The process 600 may determine (at block 605) that a connection of an MBSR to a serving network has an imminent need to transition to a target network, where the serving network is one of a TN and an NTN and the target network is another one of the TN and the NTN. In some embodiments, determining that the connection of the MBSR to the serving network has an imminent need to transition to the target network may include receiving, from the MBSR, through the serving network, a second set of one or more parameters, and determining that at least one parameter in the second set of parameters satisfies a criteria.

In some embodiments, the MBSR may be affixed to a vehicle, and the second set of one or more parameters may include at least the location of the vehicle, the speed of the vehicle, or the altitude of the vehicle. In some embodiments, receiving the second set of one or more parameters includes receiving, from the serving network, the second set of one or more parameters through one or more APIs between the MBSR operator and the serving network, and sending the message to the serving network may include using one or more APIs between the MBSR operator and the serving network.

In some embodiments, the MBSR may be affixed to a vehicle, and determining that the connection of the MBSR to the serving network has the imminent need to transition to the target network may include receiving a triggering signal from a controller of the vehicle which tracks expected movements of the vehicle, and determining that the connection of the MBSR to the serving network has the imminent need to transition to the target network based on the received triggering signal.

In some embodiments, determining that the MBSR connection to the serving network has the imminent need to transition to the target network may include determining that one or more service level requirements for the MBSR are not maintainable. In some embodiments, determining that the MBSR connection to the serving network has the imminent need to transition to the target network may include determining that a set of one or more current operational level requirements of the MBSR's installation are not maintainable.

The process 600 may send (at block 610), to the serving network, a message to select the target network and to indicate to the target network to prepare a connection between the MBSR and the target network before a determination is made for the MBSR to handover from the serving network to the target network. The message may include a first set of one or more parameters that are essential to maintain service connectivity for several UEs that are connected to the serving network through the MBSR. The process 600 may then end.

In some embodiments, selecting the target network and indicating to the target network to prepare the connection between the MBSR and the target network before the determination is made for the MBSR to handover may prevent an interruption to the service connectivity of the UEs while the connection of the MBSR is transitioning from the serving network to the target network.

The first set of parameters, in some embodiments, may include one or more of a QoS level requirement for the target network, an expected resource usage by the MBSR over the target network connection, or a maximum latency. In some embodiments, the MBSR is affixed to a vehicle. In these embodiments, the message to select the target network may further include a second set of parameters to be forwarded, by the serving network, to the target network. The second set of parameters may include one or more of the current location of the vehicle, the window of time when the MBSR is expected to make the transition, an expected travel path of the vehicle, the unique ID of the MBSR, and the expected AGL of the vehicle when a handover is expected.

The message to select the target network, in some embodiments, may further include a second set of parameters. The second set of parameters may include a prioritized list of several target networks, including the target network, from which the serving network selects a target network to connect to the MBSR.

In some embodiments, sending the message to the serving network may include sending the message, from the MBSR operator, to the serving network, through an IP connection. In some embodiments, the MBSR may be affixed to a vehicle, the MBSR may be connected to a serving cell of the serving network, the target network may include a target cell to which the MBSR is about to handover, the MBSR operator may include a service operator that operates services to the vehicle, the vehicle may include one of an airplane, a car, a bus, a train, a ship, or a boat, and the several UEs are associated with several passengers of the vehicle. In some embodiments, preparing the connection to the target network may include allocating network and RF resources before the determination to transition the MBSR from the serving network to the target network.

### Imminent Need Sent BT the MBSR

The indication of the immanent need, in some embodiments may be sent by the MBSR to the serving core network. The serving network may be the TN, and the target network may be the NTN. Alternatively, the serving network may be the NTN, and the target network may be the TN.

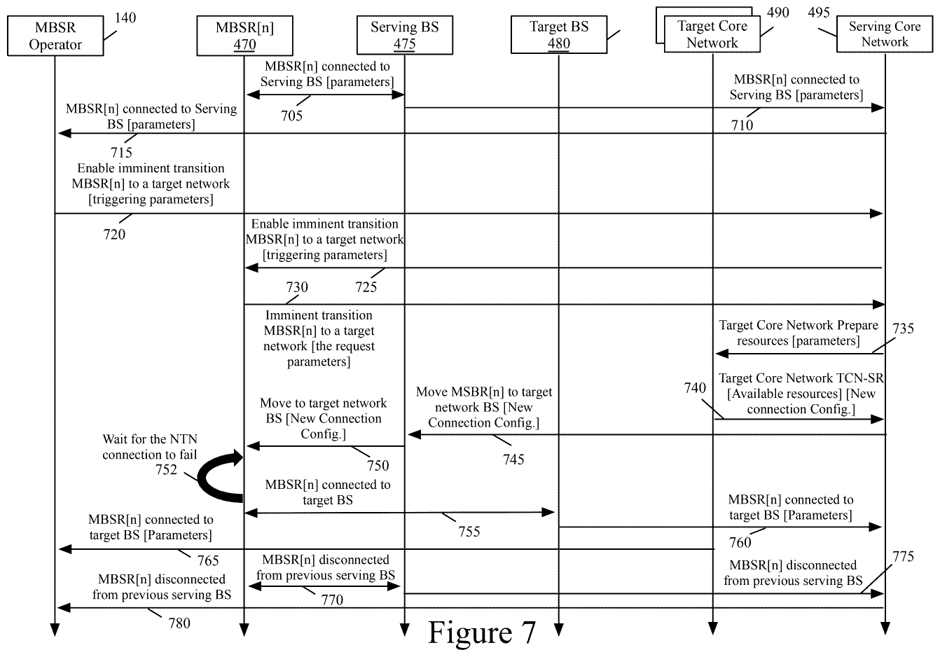

FIG. 7 is a sequence diagram illustrating an example message flow of a signaling framework where an MBSR indicates an imminent need of the MBSR to transition to a target network, according to an example implementation of the present disclosure. With reference to FIG. 7, the MBSR operator 140, the MBSR[n] 470, the serving BS 475, the target BS 480, the serving core network 495, and the target core network 490 may be similar to the corresponding entities shown in FIGS. 4 and 5.

As shown in FIG. 7, the MBSR[n] 470 may be connected (at step 705) to the serving BS 475. The serving BS 475 may receive parameters, such as, speed, altitude, location, current resource usage, etc., from the MBSR[n] 470. The parameters may be forwarded (at step 710) from the serving BS 475 to the serving core network 495. The parameters may be forwarded (at step 715) from the serving core network 495 to the MBSR operator 140.

The MBSR operator 140 may send a message (at step 720) to the serving core network 495 to enable the MBSR[n] 470 to indicate the imminent need to transition to a target network. The message may include the triggering parameters that are required to configure the MBSR to indicate the imminent need to transition. The serving core network 495 may forward (at step 725) the configuration parameters to the MBSR[n] 470.

The configuration parameters may define the conditions upon which the MBSR[n] 470 may send an indication of immanent need to the serving core network 495. The presence or lack of presence of a parameter may enable or disable the MBSR[n] 470 to send an indication of imminent need to the serving core network 495. The MBSR[n] 470 may send an indication of imminent need to the serving core network when enabled by parameter(s) and when the conditions at the MBSR[n] 470 satisfy the condition of the parameter(s).

In some embodiments, the MBSR[n] 470 may be configured by the MBSR operator 140 with one or more commands that enable the MBSR[n] 470 to accept from source(s) external to the MBSR[n] 470 an input into the MBSR[n] 470 that may trigger the MBSR[n] 470 to send an indication of imminent need to the serving core network 495.

In some embodiments, the MBSR[n] 470 may be configured by an MBSR operator 140 with both command(s) and parameters that enable the MBSR[n] 470 to send an indication of imminent need to the serving core network. In some embodiments, the MBSR[n] 470 may be configured by an MBSR operator 140 with a data set. The data set may include at least a list of prioritized target core networks, the minimum expected service level requirements of the MBSR[n] 470, and information regarding the operational aspects of the MBSR[n] 470.

The MBSR operator may receive the parameters (at step 715), and may send the message to the serving core network 495 (at step 720) through a set of APIs that are provided by the serving core network 495.

The MBSR[n] 470 may send (at step 730) an indication of an imminent need to transition MBSR[n] 470 to a target network. The indication may be transported, from MBSR[n] 470 to the serving core network 495 via Non-Access Stratum (NAS) layer (e.g., over the top of the Uu and Next Generation (NG) interfaces that connects the MBSR[n] 470 to the serving BS 475 and the serving BS 475 to the serving core network 495. In other embodiments, the MBSR[n] 470 may send the indication of immanent need to the serving BS 475 of the serving core network 495 via a control channel of the Uu interface. The serving BS 475 of the serving core network 495 may then forward the indication of imminent need of the MBSR[n] 470 to the serving core network 495 via the NG interface.

The indication of imminent need may include a first set of parameters. The first set of parameters may include information regarding the expected service level required by the MBSR[n] 470 (e.g., the QoS level that a target core network service is required provide, the expected resource usage by the MBSR[n] over the target core network connection, a latency maximus, etc.).

The indication of imminent need may also include a second set of parameters. The second set of parameters may include information regarding the operational aspects of the MBSR[n] 470. The second set of parameters may include the current location of MBSR[n] 470, the expected window of time when MBSR[n] 470 may need to make the transition, the expected travel path of MBSR[n] 470, the unique ID of MBSR[n] 470, the expected aircraft AGL (e.g., when the vehicle on which the MBSR[n] 470 is affixed is an airplane) when the handover is expected, and other essential information related to the continuity of services currently required by the MBSR[n] 470.

The indication of imminent need may also include a third set of parameters. The third set of parameters may include a prioritized list of target core networks from which the serving core network may select from to make a request to reserve sufficient resources to service the imminent connection of the MBSR[n] 470.

Upon receipt of an indication of immanent need, the serving core network 495 may select, from the list of prioritized target core networks, a first target core network of highest priority to check if it is able to reserve sufficient resources to service the imminent connection of MBSR[n] 470. The definition of sufficient resources may be defined by the first and second parameter sets as received by the serving core network 495. The serving core network 495 may send a request (at step 735) to the selected target core network 490 to request the target core network 490 to reserve and prepare the necessary resources to support a new MBSR[n] 470 connection. Details of the selection of a target network to service the new MBSR connection were described above with reference to FIGS. 4 and 5.

Once the serving core network 495 selects the best target core network to provide the new connection to the MBSR[n] 470, the target core network 490 may send (at step 740) a status report (e.g., a TCN-SR) to the serving core network 495 to indicate the resources that has been (or has not been) allocated. The TCN-SR may include an NCC to be used by the MBSR[n] 470 when connecting to the target BS 480. The NCC may include information regarding the use of the target network RF resources by the MBSR[n] 470 when the MBSR attempts to connect to and maintain a connection to the target BS 480 of the target core network 490.

The serving core network 495 may send (at step 745) the NCC to the serving BS 475 to which MBSR[n] 470 is connected to indicate to the MBSR[n] 470 to be prepared to move to the target BS 480. The target BS 480 may send (at step 750) the NCC to MBSR[n] 470 with a command to prepare to handover to the target BS 480 when the serving BS link fails. In some embodiments, the serving BS 495 may instead command MBSR[n] 470 to immediately handover to the target BS 480. In other embodiments, the serving BS 495 may command MBSR[n] 470 to wait for some local conditions to be met (e.g., speed, location, altitude AGL, etc.) before the handover to the target BS 480. In some embodiments, the serving BS 495 may command MBSR[n] 470 to wait for an external signal the handover to the target BS 480.

MBSR[n] 470 may wait (at step 752) for the condition(s) indicated by the serving core network 495 to be satisfied to handover to the target BS 480. When the condition(s) for handover is/are satisfied, the MBSR[n] 470 may activate a DAPS feature to maintain a connection with the serving BS 495 while simultaneously establishing a connection with the target BS 480.

MBSR[n] 470 may connect (at step 755) to the target BS 480. The target BS 480 may send (at step 760) the MBSR[n] 470 status parameters (e.g., location, speed, altitude, current resource usage, etc.) to the target core network 490. The target core network 490 may provide (at step 765) the MBSR[n] status parameters to the MBSR operator 140 to monitor. The target core network 490 may provide the status parameters to the MBSR operator 140, for example, through a set of APIs.

The previous serving BS 475 and MBSR[n] 470 may complete (at step 770) the disconnection of the MBSR[n] 470 from the previous serving BS 475. The previous serving BS 475 may indicate (at step 775) to the previous serving core network 495 that MBSR[n] 470 is disconnected from the BS 475. The core network 495 may indicate (at step 780) to the MBSR operator 140 (e.g., through the APIs provided by the core network 495 to the MBSR operator 140) that the connection between MBSR[n] 470 and the BS 475 is disconnected.

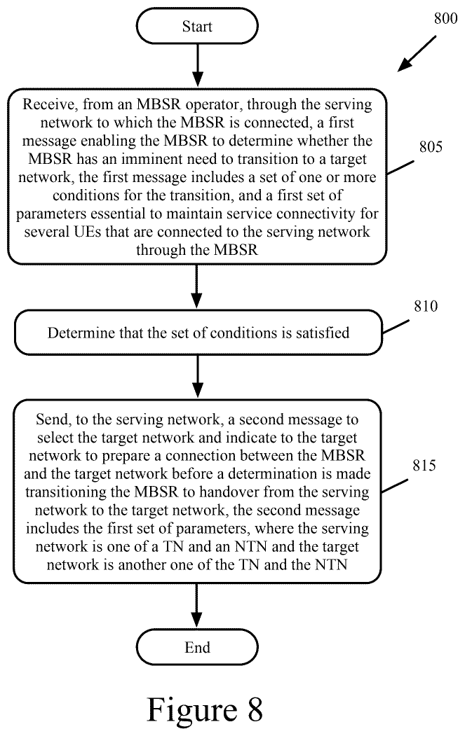

FIG. 8 is a flowchart illustrating an example method/process 800 performed by an MBSR for indicating an imminent need of the MBSR to transition to a target network connectivity, according to an example implementation of the present disclosure. With reference to FIG. 8, the process 800 may be performed by at least one processor of an MBSR, such as the MBSR 130 or 135, shown in FIG. 1.

The process 800 may receive (at block 805), from an MBSR operator, through the serving network to which the MBSR is connected, a first message enabling the MBSR to determine whether the MBSR has an imminent need to transition to a target network. The first message may include a set of one or more conditions for the transition, and a first set of parameters essential to maintain service connectivity for several UEs that are connected to the serving network through the MBSR.

The first set of parameters may include one or more of the QoS level requirement for the target network, the expected resource usage by the MBSR over the target network connection, and a maximum latency.

The process 800 may determine (at block 810) that the set of conditions is satisfied. In some embodiments, the first message may further include the identification of a second set of parameters. In these embodiments, determining that the set of conditions is satisfied may include monitoring values of the second set of parameters, and determining that the second set of parameters satisfy one or more criteria.

In some embodiments, the process 800 may receive, from the MBSR operator, a configuration enabling the MBSR to receive, from a source external to the MBSR, an input into the MBSR indicating the imminent need to transition. In these embodiments, determining that the at the set of the conditions is satisfied may include receiving, from the source external to the MBSR, the input indicating the imminent need to transition.

In some embodiments, the process 800 may receive, from the serving network, a command to prepare to handover to the target network. The command may include a TCN-SR received from an operator of the target network. The TCN-SR may include an NCC. The process 800 may then execute the handover using the NCC. In some embodiments, the TCN-SR further includes configuration information regarding the use of the target network RF resources by the MBSR when the MBSR attempts to connect to and maintain a connection to the BS of the target network.

The process 800 may send (at block 815), to the serving network, a second message to select the target network and indicate to the target network to prepare a connection between the MBSR and the target network before a determination is made transitioning the MBSR to handover from the serving network to the target network, the second message includes the first set of parameters, where the serving network is one of a TN and an NTN and the target network is another one of the TN and the NTN. The process 800 may then end.

In some embodiments, selecting the target network and indicating to the target network to prepare the connection between the MBSR and the target network before the determination is made for the MBSR to handover may prevent an interruption to the service connectivity of the several UEs while the connection of the MBSR is transitioning from the serving network to the target network.

In some embodiments, the MBSR may be affixed to a vehicle. In these embodiments, the second set of one or more parameters may include at least one of a location of the vehicle, a speed of the vehicle, or an altitude of the vehicle. In some embodiments, the process 800 may activate a DAPS to maintain the connection with the serving network while simultaneously establishing a connection with the target network.

In some embodiments, sending the second message to the serving network may include sending the second message, to the serving network, via a NAS layer. In some embodiments, sending the second message to the serving network may include sending the second message, to the serving network, through a BS of the serving network via a control channel of a Uu air interface, and from the BS to the serving network via an NG interface.

The process 800 may, in some embodiments, receive a second set of parameters that includes a prioritized list of several target networks from which the serving network to select the target network. In these embodiments, the second message may further include the second set of parameters.

The MBSR, in some embodiments, may be affixed to a vehicle. In these embodiments, the process 800 may receive, from the MBSR operator, a second set of parameters that may include one or more of the current location of the vehicle, the window of time when the MBSR is expected to make the transition, the expected travel path of the vehicle, the unique ID of the MBSR, the expected AGL of the vehicle when a handover is expected. In these embodiments, the second message further includes the second set of parameters to be forwarded, by the serving network, to the target network.

The MBSR, in some embodiments, may be affixed to a vehicle. In these embodiments, the MBSR may be connected to a serving cell of the serving network, the target network may include a target cell to which the MBSR is about to handover, the MBSR operator may include a service operator that operates services to the vehicle, the vehicle may include one of an airplane, a car, a bus, a train, a ship, or a boat, and the several UEs are associated with several passengers of the vehicle.

Execution of Transition From the Serving Core Network to the Target Core Network

As described above, the core network of a TN that is connected to an MBSR may receive an indication of imminent need for the MBSR to transition its connection from the TN BS to an NTN BS. Alternately, the core network of an NTN that is connected to an MBSR may receive an indication of imminent need for the MBSR to transition its connection from the NTN BS to a TN BS.

In some embodiments, the indication of immanent need may be sent by the MBSR operator to the serving core network (e.g., as described above with reference to FIGS. 2 to 6). The indication from the MBSR operator to the serving core network may be received by a set of APIs provided by the serving core network. The MBSR operator may use an IP connection to access the serving core network's APIs.

Alternately, the indication of immanent need may be sent by the MBSR to the serving core network (e.g., as described above with reference to FIGS. 3 to 4 and 7 to 8). The indication from the MBSR to the serving core network may be transported from the MBSR to the serving core network via NAS layer (e.g., over the top of the Uu and NG interfaces that connects the MBSR to the serving BS and the serving BS to the serving core network).

The indication of imminent need may also include a first set of parameters. The first set of parameters may include information regarding the expected service level required by the MBSR (e.g., the QoS level that a target core network service should provide, the expected resource usage by the MBSR over the target core network connection, latency maximus, etc.).

The indication of imminent need may also include a second set of parameters. The second set of parameters may include information regarding the operational aspects of the MBSR (e.g., the current location of the MBSR, the expected window of time when the MBSR may need to make the transition, the expected travel path of the MBSR, the unique ID of the MBSR, the expected aircraft AGL when the handover is expected) and other essential information related to the continuity of services currently required by the MBSR.

Upon the receipt of an indication of immanent need, the serving core network may request (e.g., as described with reference to steps 225 (FIGS. 2), 325 (FIG. 3), or 735 (FIG. 7)) a target core network whether the target core network is able to reserve sufficient resources to service the imminent connection of the MBSR. The definition of sufficient resources may be defined by the first and second parameter sets as received by the serving core network.

A target core network may reply (e.g., as described with reference to steps 230 (FIGS. 2), 330 (FIG. 3), or 740 (FIG. 7)) to the serving core network with a TCN-SR in response to the request for immanent connection of an MBSR. The TCN-SR may indicate the level of resources that the target core network is able to allocate in support the immanent connection of an MBSR per the first and second parameter set.

The TCN-SR from the target core network to the serving core network may also include configuration information regarding the use of target network RF resources by the MBSR when the MBSR attempts to connect to and maintain a connection to the target BS of the target core network.

The serving core network may determine (e.g., as described above with reference to step 445 (FIG. 4) and step 545 (FIG. 5)) via the content of a TCN-SR that a target core network may be able to provide sufficient resources to support and maintain the service continuity of the MBSR with the immanent need. In which case the serving core network may request (e.g., as described above with reference to step 235 (FIGS. 2), 335 (FIG. 3), and step 745 (FIG. 7)) the serving BS of the serving core network connected to the MBSR to command the MBSR to transition to the target BS of the target core network with sufficient resources when the RF link fails between the serving BS of the serving core network and the MBSR.

Alternatively, the serving core network may request the serving BS of the serving core network connected to the MBSR to command the MBSR to immediately transition to the Target BS of the target core network with sufficient resources. Alternately, the serving core network may determine via the content of a TCN-SR that a target core network is able to provide sufficient resources to support and maintain the service continuity of the MBSR with the immanent need. In which case the serving core network may request the serving BS of the serving core network connected to the MBSR to command the MBSR to prepare for a transition to the Target BS of the Target core network with sufficient resources when certain conditions at the MBSR are met, such as altitude or speed.

The serving core network may determine via the content of a TCN-SR that a target core network may be able to provide sufficient resources to support and maintain the service continuity of the MBSR with the immanent need. In which case the serving core network may forward to the MBSR the configuration information regarding the use of that target network RF resources by the MBSR when the MBSR attempts to connect to and maintain a connection to the Target BS of the target core network.

The MBSR, upon receipt of a command to transition from a serving BS of the serving core network to target BS of the target core network (either immediately or after waiting for RF failure or a set of conditions to be met), may employ (e.g., as described above with reference to step 245 (FIG. 2), step 345 (FIG. 3), and step 752 (FIG. 7)) a DASP feature. The MBSR may use the configuration information regarding the target network RF resources to configure the second protocol stack of the DASP when attempting to establish a connection to the target BS of the target core network, while using the first protocol stack of the DASP to maintain the connection to the serving BS of the serving core network. Such a feature may allow the MBSR to continue the connection with the serving BS of the serving core network while setting up a connection to the target BS of the target core network (e.g., a Make-Before-Break type operation).

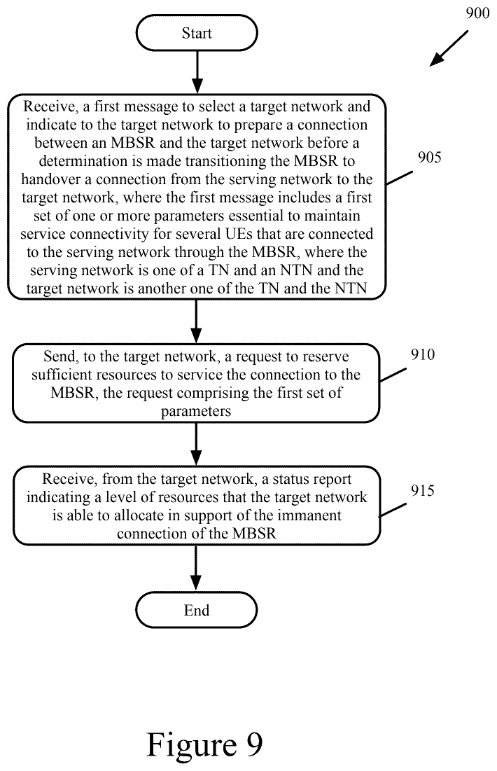

FIG. 9 is a flowchart illustrating an example method/process 900 performed by a serving network to select a target network and request the target network to prepare a connection between an MBSR and the target network, according to an example implementation of the present disclosure. With reference to FIG. 9, the process 900 may be performed by at least one processor of serving core network, such as the serving core networks 111 (FIGS. 2 and 3), 495 (FIGS. 4, 5, and 7).

The process 900 may receive (at block 905) a first message to select a target network and indicate to the target network to prepare a connection between an MBSR and the target network before a determination is made transitioning the MBSR to handover a connection from the serving network to the target network. The first message may include a first set of one or more parameters essential to maintain service connectivity for several UEs that are connected to the serving network through the MBSR. The serving network may be one of a TN and an NTN and the target network may be another one of the TN and the NTN.

Selecting the target network and indicating to the target network to prepare the connection between the MBSR and the target network before the determination is made for the MBSR to handover may prevent an interruption to the service connectivity of the several UEs while the connection of the MBSR is transitioning from the serving network to the target network. The first message, in some embodiments, may be received from one of the MBSR or an operator of the MBSR. The first set of parameters, in some embodiments, may include one or more of the QoS level requirement for the target network, the expected resource usage by the MBSR over the target network connection, and a maximum latency.

The MBSR, in some embodiments, may be affixed to a vehicle, the first message may further include a second set of parameters that may include one or more of the current location of the vehicle, the window of time when the MBSR is expected to make the transition, the expected travel path of the vehicle, the unique ID of the MBSR, the expected AGL of the vehicle when a handover is expected. In these embodiments, sending the second message to the target network may further include sending the second set of parameters.

The process 900 may send(at block 910), to the target network, a request to reserve sufficient resources to service the connection to the MBSR. The request may include the first set of parameters.

The process 900 may receive (at block 915), from the target network, a status report indicating a level of resources that the target network is able to allocate in support of the immanent connection of the MBSR. The process 900 may then end. The status report may include a TCN-SR that may include an NCC. The process 900 may send, to the MBSR, the NCC.

The TCN-SR may further include configuration information regarding the use of the target network RF resources by the MBSR when the MBSR attempts to connect to and maintain a connection to a BS of the target network. The process 900 may determine, from the status report, that the target network has sufficient resources to support and maintain a service continuity of the MBSR, and may send, to the MBSR, the configuration information when the MBSR attempts to connect to, and maintain a connection with, a BS of the target network.

The MBSR may maintain a first protocol stack for a connection with a BS of the serving network, and the configuration may be for the MBSR to configure a DAPS to use a second protocol stack when attempting to establish a connection to a BS of the target network while simultaneously maintaining the connection with the BS of the serving network using the first protocol stack.

The process 900 may determine, from the status report, that the target network has sufficient resources to support and maintain a service continuity of the MBSR, and may send, to a serving BS of the serving network, a request to command the MBSR to transition to a BS of the target network when a connection between the BS of the serving network and the MBSR fails.

The process 900 may determine, from the status report, that the target network has sufficient resources to support and maintain a service continuity of the MBSR, and may send, to a BS of the serving network that is connected to the MBSR, a request to command the MBSR to immediately transition to a BS of the target network.

The process 900 may determine, from the status report, that the target network has sufficient resources to support and maintain a service continuity of the MBSR, and may send, to a BS of the serving network that is connected to the MBSR, a request to command the MBSR to prepare for a transition to a BS of the target network when one or more conditions at the MBSR are met.

The MBSR may be affixed to a vehicle, and the one or more conditions may be one or more of the altitude of the vehicle or the speed of the vehicle. The MBSR may be affixed to a vehicle, the MBSR may be connected to a serving cell of the serving network, the target network may include a target cell to which the MBSR is about to handover, and an operator of the MBSR may include a service operator that operates services to the vehicle. The vehicle, in some embodiments, may include one of an airplane, a car, a bus, a train, a ship, or a boat, and the several UEs may be associated with several passengers of the vehicle.

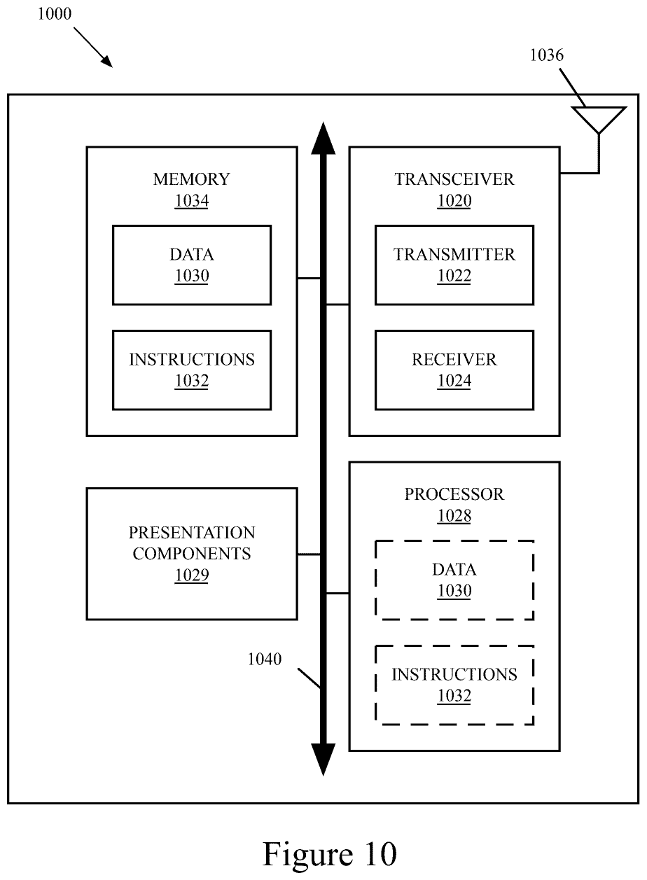

FIG. 10 is a block diagram illustrating a node 1000 for wireless communication, according to an example implementation of the present disclosure. As illustrated in FIG. 10, a node 1000 may include a transceiver 1020, a processor 1028, a memory 1034, one or more presentation components 1029, and at least one antenna 1036. The node 1000 may also include a radio frequency (RF) spectrum band module, a BS communications module, a network communications module, and a system communications management module, Input/Output (I/O) ports, I/O components, and a power supply (not illustrated in FIG. 10).

Each of the components may directly or indirectly communicate with each other over one or more buses 1040. The node 1000 may be a UE, a BS, an MBSR, an MBSR operator, a gateway, or components of a core network that performs various functions disclosed with reference to FIGS. 1 through 9.

The transceiver 1020 has a transmitter 1022 (e.g., transmitting/transmission circuitry) and a receiver 1024 (e.g., receiving/reception circuitry) and may be configured to transmit and/or receive time and/or frequency resource partitioning information. The transceiver 1020 may be configured to transmit in different types of subframes and slots including, but not limited to, usable, non-usable, and flexibly usable subframes and slot formats. The transceiver 1020 may be configured to receive data and control channels.

The node 1000 may include a variety of computer-readable media. Computer-readable media may be any available media that may be accessed by the node 1000 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1034 may include computer-storage media in the form of volatile and/or non-volatile memory. The memory 1034 may be removable, non-removable, or a combination thereof. Example memory may include solid-state memory, hard drives, optical-disc drives, etc. As illustrated in FIG. 10, the memory 1034 may store a computer-readable and/or computer-executable instructions 1032 (e.g., software codes) that are configured to, when executed, cause the processor 1028 to perform various functions disclosed herein. Alternatively, the instructions 1032 may not be directly executable by the processor 1028 but may be configured to cause the node 1000 (e.g., when compiled and executed) to perform various functions disclosed herein.

The processor 1028 (e.g., having processing circuitry) may include an intelligent hardware device, e.g., a Central Processing Unit (CPU), a microcontroller, an ASIC, etc. The processor 1028 may include memory. The processor 1028 may process the data 1030 and the instructions 1032 received from the memory 1034, and information transmitted and received via the transceiver 1020, the baseband communications module, and/or the network communications module. The processor 1028 may also process information to send to the transceiver 1020 for transmission via the antenna 1036 to the network communications module for transmission to a CN.

One or more presentation components 1029 may present data indications to a person or another device. Examples of presentation components 1029 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment can also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A mobile base station relay (MBSR), comprising:
one or more non-transitory computer-readable media storing one or more computer-executable instructions; and
at least one processor coupled to the one or more non-transitory computer-readable media, and configured to execute the one or more computer-executable instructions to cause the MBSR to:
receive, from an MBSR operator, through a serving network to which the MBSR is connected, a first message enabling the MBSR to determine whether the MBSR has an imminent need to transition to a target network, the first message comprising a set of one or more conditions for the transition, and a first set of parameters essential to maintain service connectivity for a plurality of user equipment (UEs) that is connected to the serving network through the MBSR;
determine that the set of conditions is satisfied;
send, to the serving network, a second message to select the target network and indicate to the target network to prepare a connection between the MBSR and the target network before a determination is made transitioning the MBSR to handover from the serving network to the target network, the second message comprising the first set of parameters,
wherein the serving network is one of a terrestrial network (TN) and a non-terrestrial network (NTN) and the target network is another one of the TN and the NTN.

2. The MBSR of claim 1, wherein selecting the target network and indicating to the target network to prepare the connection between the MBSR and the target network before the determination is made for the MBSR to handover prevents an interruption to the service connectivity of the plurality of UEs while the connection of the MBSR is transitioning from the serving network to the target network.

3. The MBSR of claim 1, wherein:
the first set of parameters comprises one or more of a quality of service (QoS) level requirement for the target network, an expected resource usage by the MBSR over the target network connection, and a maximum latency.

4. The MBSR of claim 1,
wherein the first message further comprises, an identification of a second set of parameters, and
wherein determining that the set of conditions is satisfied comprises:
monitoring values of the second set of parameters, and
determining that the second set of parameters satisfy one or more criteria.

5. The MBSR of claim 3, wherein:
the MBSR is affixed to a vehicle, and
the second set of one or more parameters comprises at least one of a location of the vehicle, a speed of the vehicle, or an altitude of the vehicle.

6. The MBSR of claim 1,
wherein the at least one processor is further configured to execute the one or more computer-executable instructions to cause the MBSR to:
receive, from the MBSR operator, a configuration enabling the MBSR to receive, from a source external to the MBSR, an input into the MBSR indicating the imminent need to transition, and
wherein determining that the at the set of the conditions is satisfied comprises receiving, from the source external to the MBSR, the input indicating the imminent need to transition.

7. The MBSR of claim 1,
wherein the at least one processor is further configured to execute the one or more computer-executable instructions to cause the MBSR to:
receive, from the serving network, a command to prepare to handover to the target network, the command comprising a time critical networking-scheduling request (TCN-SR) received from an operator of the target network, the TCN-SR comprising a new connection configuration (NCC); and
execute the handover using NCC.

8. The MBSR of claim 7, wherein:
the TCN-SR further comprises configuration information regarding a use of the target network radio frequency (RF) resources by the MBSR when the MBSR attempts to connect to and maintain a connection to a base station (BS) of the target network.

9. The MBSR of claim 7,
wherein the at least one processor is further configured to execute the one or more computer-executable instructions to cause the MBSR to:
activate a dual active protocol stack (DAPS) to maintain a connection with the serving network while simultaneously establishing a connection with the target network.

10. The MBSR of claim 1, wherein sending the second message to the serving network comprises sending the second message, to the serving network, via a non-access stratum (NAS) layer.

11. The MBSR of claim 1, wherein sending the second message to the serving network comprises sending the second message, to the serving network, through a base station (BS) of the serving network via a control channel of a Uu air interface, and from the BS to the serving network via a next generation (NG) interface.

12. The MBSR of claim 1,
wherein the at least one processor is further configured to execute the one or more computer-executable instructions to cause the MBSR to:
receive a second set of parameters comprising a prioritized list of a plurality of target networks from which the serving network to select the target network,
wherein the second message further comprises the second set of parameters.

13. The MBSR of claim 1,
wherein the MBSR is affixed to a vehicle,
wherein the at least one processor is further configured to execute the one or more computer-executable instructions to cause the MBSR to:
receive, from the MBSR operator, a second set of parameters comprising one or more of a current location of the vehicle, a window of time when the MBSR is expected to make the transition, an expected travel path of the vehicle, a unique identification (ID) of the MBSR, an expected above the ground level (AGL) of the vehicle when a hand-over is expected, and
wherein the second message further comprises the second set of parameters to be forwarded, by the serving network, to the target network.

14. The MBSR of claim 1, wherein:
the MBSR is affixed to a vehicle,
the MBSR is connected to a serving cell of the serving network,
the target network comprises a target cell to which the MBSR is about to handover,
the MBSR operator comprises a service operator that operates services to the vehicle,
the vehicle comprises one of an airplane, a car, a bus, a train, a ship, or a boat, and
the plurality of UEs is associated with a plurality of passengers of the vehicle.

15. A method, comprising:
receiving, at a mobile base station relay (MBSR), from an MBSR operator, through a serving network to which the MBSR is connected, a first message enabling the MBSR to determine whether the MBSR has an imminent need to transition to a target network, the first message comprising a set of one or more conditions for the transition, and a first set of parameters essential to maintain service connectivity for a plurality of user equipment (UEs) that is connected to the serving network through the MBSR;
determining that the set of conditions is satisfied;
sending, to the serving network, a second message to select the target network and indicate to the target network to prepare a connection to between the MBSR and the target network before a determination is made transitioning the MBSR to handover from the serving network to the target network, the second message comprising the first set of parameters,
wherein the serving network is one of a terrestrial network (TN) and a non-terrestrial network (NTN) and the target network is another one of the TN and the NTN.
